(19) United States
(12) Patent Application Publication
(10) Pub. No.: US 2017/0200159 A1
(43) Pub. Date: Jul. 13, 2017

(54) SECURE PAYMENT DEVICE AND SECURE PAYMENT METHOD THEREOF

(71) Applicant: Compal Electronics, Inc., Taipei (TW)

(72) Inventors: Shih-Cheng Chou, Taipei (TW); Chih-Hou Wang, Taipei (TW); Wei-Fan Chen, Taipei (TW); Hsing-Ju Chen, Taipei (TW)

(21) Appl. No.: 15/397,691

(22) Filed: Jan. 3, 2017

Related U.S. Application Data
(60) Provisional application No. 62/277,443, filed on Jan. 11, 2016.

(51) Int. Cl. G06Q 20/40; G06F 3/14; G06F 3/0488; G06Q 20/10; G06Q 20/32

(52) U.S. Cl. CPC G06Q 20/401; G06Q 20/102; G06Q 20/3227; G06Q 20/3278; G06F 3/04886; G06F 3/1423

(57) ABSTRACT

A secure payment device having first and second modes is provided. In the second mode, a payment procedure is activated to receive data of a payment member for a secure payment. The secure payment device includes a touch screen group, a payment unit, a central processing unit and a secure microprocessor unit. The touch screen group displays an operation interface and a secure payment interface. In the first mode, the operation interface receives a first operation instruction via the operation interface. In the second mode, the secure payment interface obtains the data of the payment member by the payment unit, receive the second operation instruction via the secure payment interface, and activate the payment function based on a comparing result of the authentication information and the data of the payment member. A secure payment method for the aforementioned secure payment device is also provided.

### FIELD OF THE INVENTION

The present invention relates to a secure payment device and a secure payment method thereof, and more particularly to a secure payment device and a secure payment method thereof capable of preventing financial transaction data from being eavesdropped.

### BACKGROUND OF THE INVENTION

Due to the modern spending habits, most people use credit cards or smart phones with near field communication (NFC) function for a spending checkout. Today, a checkout can be completed by simply sliding the credit card to a card device or sensing the smart phone to a sensor device provided by shops. Thus, the checkout process is easy and convenient.

However, such spending checkout has a certain degree of risk. For example, when a consumer uses a credit card or smart phone for spending checkout and if a card device or sensor device corresponding to the credit card or smart phone is installed with an eavesdropper, the consumer's financial transaction data may be stolen and a pseudo-card may be made, which may lead to a serious loss of the consumer's property.

Therefore, how to avoid the above-mentioned card device or the sensor device to be installed with an eavesdropper thereby avoiding the consumer's financial transaction data to be stolen and increasing the consumer security is a main focus of the present invention.

### SUMMARY OF THE INVENTION

One objective of the present invention is to provide a secure payment device that avoids the eavesdropping of financial transaction data of a consumer.

Another objective of the present invention is to provide a secure payment device having increased security.

Still another objective of the present invention is to provide a secure payment method for a secure payment device, in which the eavesdropping of financial transaction data of a consumer is avoided while the consumer is performing a checkout.

The present invention provides a secure payment device having a first mode and a second mode. In the second mode, a payment procedure is activated to receive data of a payment member for a secure payment. The secure payment device includes a touch screen group, a payment unit, a central processing unit and a secure microprocessor unit. The touch screen group is configured to display an operation interface and a secure payment interface. In the first mode, the operation interface is configured to receive a first operation instruction. In the second mode, the secure payment interface is configured to receive a second operation instruction. The second operation instruction includes authentication information for activating a payment function of the payment member. The payment unit is configured to obtain the data of the payment member. The central processing unit is signal connected to the touch screen group. In the first mode, the central processing unit is configured to receive the first operation instruction via the operation interface. The secure microprocessor unit is signal connected to the central processing unit, the touch screen group and the payment unit. In the second mode, the secure microprocessor unit is configured to obtain the data of the payment member by the payment unit, receive the second operation instruction via the secure payment interface, and activate the payment function based on a comparing result of the authentication information and the data of the payment member.

The present invention further provides a secure payment method for the aforementioned secure payment device. The secure payment method includes steps of: a) in the first mode, configuring central processing unit to receive a first operation instruction via the operation interface; b) in the second mode, configuring the secure microprocessor unit to obtain the data of the payment member by the payment unit; c) configuring the secure microprocessor unit to receive a second operation instruction via the secure payment interface, wherein the second operation instruction comprises authentication information for activating a payment function of the payment member; and d) configuring the secure microprocessor unit to activate the payment function based on a comparing result of the authentication information and the data of the payment member.

The present invention provides a secure payment device and a secure payment method thereof. The secure payment device has a first mode and a second mode. When the consumer wants to perform a checkout, the secure payment device is switched to the second mode. At this time, a secure microprocessor unit is for receiving the financial transaction data and verifying the connection to the consumer independently. Because a central processing unit is for controlling and driving the secure payment device only, the central processing unit cannot obtain any data processed or received by the secure microprocessor unit. Because the secure microprocessor unit is independently operated, therefore, for those who want to eavesdrop the secure payment device, the financial transaction data cannot be eavesdropped even when an eavesdropper is installed to eavesdrop all the control processes of the central processing unit. Thus, security of the secure payment device of the present invention is improved significantly.

### BRIEF DESCRIPTION OF THE DRAWING

FIG. 1 is a block diagram of a secure payment device in accordance with an embodiment of the present invention;

FIG. 2 is a flow chart of a secure payment method for the secure payment device shown in FIG. 1 in accordance with an embodiment of the present invention;

FIG. 3 is a schematic side view of an operation touch screen and a payment touch screen of the secure payment device shown in FIG. 1 in accordance with an embodiment of the present invention.

FIG. 4 is a block diagram of a secure payment device in accordance with another embodiment of the present invention;

FIG. 5 is a flow chart of a secure payment method for the secure payment device shown in FIG. 4 in accordance with an embodiment of the present invention; and

FIG. 6 is a schematic view of a virtual keyboard of a secure payment interface of the secure payment device shown in FIG. 4.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

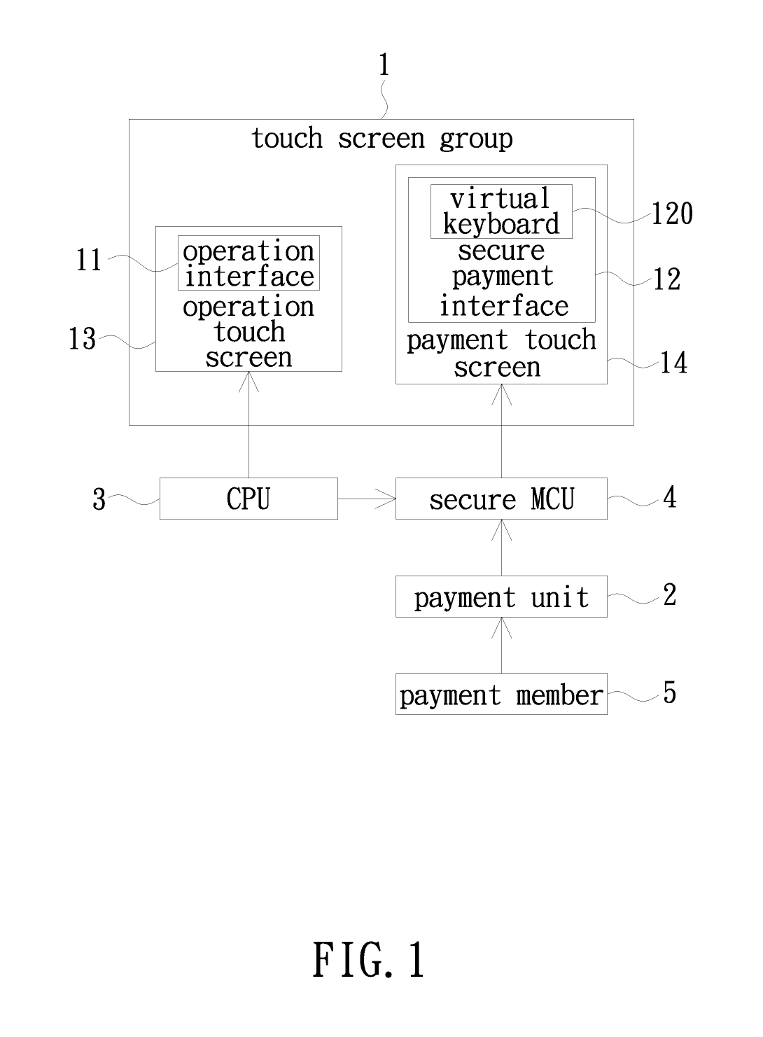

FIG. 1 is a block diagram of a secure payment device in accordance with an embodiment of the present invention; wherein the secure payment device has a first mode and a second mode. As shown in FIG. 1, the secure payment device of the present embodiment includes a touch screen group 1, a payment unit 2, a central processing unit (CPU) 3 and a secure microprocessor unit (MCU) 4. The touch screen group 1 is configured to display an operation interface 11 and a secure payment interface 12. In the embodiment, the touch screen group 1 includes an operation touch screen 13 and a payment touch screen 14. The operation touch screen 13 is signal connected to the central processing unit 3 and configured to display the operation interface 11 for a holder to operate. The payment touch screen 14 is signal connected to the secure microprocessor unit 4 and configured to display the secure payment interface 12 for a consumer to operate.

In the first mode, the operation interface 11 is provided for the holder to operate. In the present embodiment, the operation interface 11 may be, for example, a menu interface for the service provider to click. In the second mode, the secure payment interface 12 is provided for the consumer to operate to perform a secure payment procedure. For example, when the consumer makes a secure payment through the data of his/her payment member 5, the consumer may enter corresponding authentication information via the secure payment interface 12. The authentication information may be, for example, password information, fingerprint information, iris information or a combination thereof, but the present invention is not limited thereto. In the present embodiment, the authentication information is exemplified by password information; and correspondingly, the secure payment interface 12 includes, for example, a virtual keyboard 120 allowing the consumer to enter the aforementioned password information.

In the present embodiment, the payment member 5 may be a chip credit card or a near field communication (NFC) medium (such as a sensible credit card or a smart phone with NFC function). The payment unit 2 is configured to obtain the data of the payment member 5 of the consumer, and the payment unit 2 may be a chip card reader or a NFC reader.

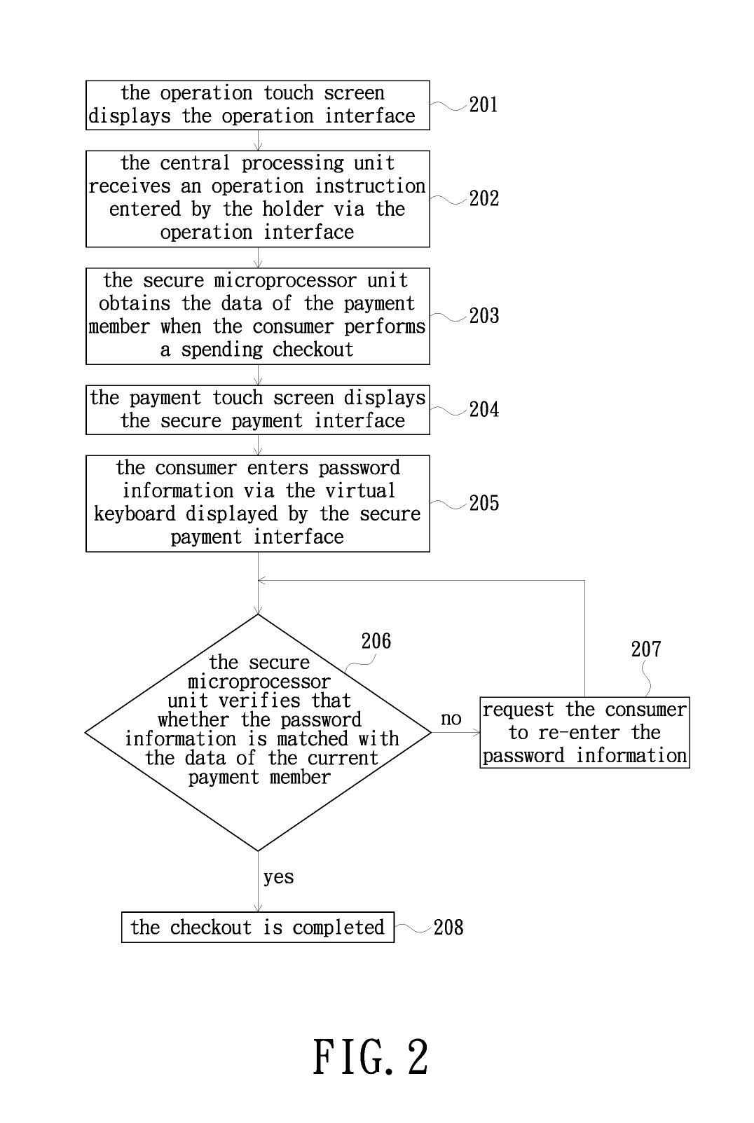

FIG. 2 is a flow chart of a secure payment method for the secure payment device shown in FIG. 1 in accordance with an embodiment of the present invention. Please refer to FIGS. 1 and 2 together. First, the operation touch screen 13 displays the operation interface 11 for the holder to operate (step 201). Thereafter, in the first mode, the central processing unit 3 receives a first operation instruction entered by the holder via the operation interface 11 (step 202). Thereafter, when the consumer wants to perform a checkout, in the second mode the secure microprocessor unit 4 obtains the data of the payment member 5 through the payment unit 2 to perform a secure payment (step 203). Thereafter, the payment touch screen 14 displays the secure payment interface 12 for the consumer to operate (step 204). Thereafter, the secure microprocessor unit 4 receives a second operation instruction via the secure payment interface 12 (step 205). The second operation instruction includes a set of authentication information for activating the payment function of the payment member 5, and the authentication information may be, for example, password information, fingerprint information, iris information or a combination thereof. In the present embodiment, the secure microprocessor unit 4 receives a set of password information entered by the consumer via the virtual keyboard 120 displayed by the secure payment interface 12. Thereafter, the secure microprocessor unit 4 verifies that whether the password information is matched with the data of the current payment member 5 (step 206). If it does not match, then the consumer is requested to re-enter the password information (step 207) and the process of the secure payment method returns to step 206. Alternatively, if it matches, the payment function of the payment member 5 is activated and the consumer completes the checkout (step 208).

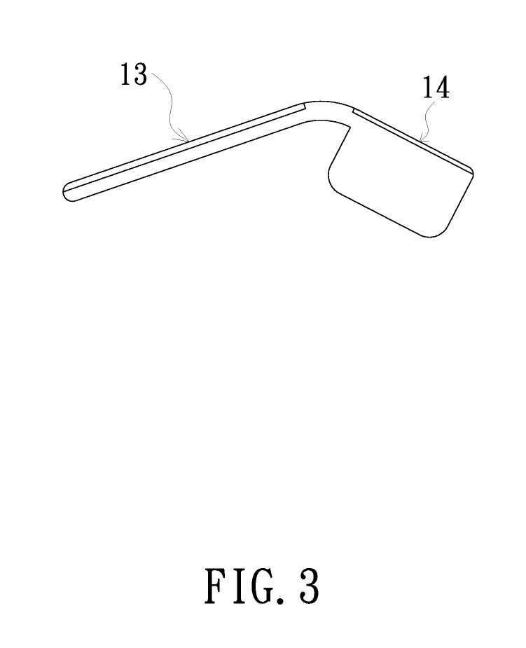

FIG. 3 is a schematic side view of an operation touch screen and a payment touch screen of the secure payment device shown in FIG. 1 in accordance with an embodiment of the present invention. As shown, in the present embodiment, the top end of the operation touch screen 13 and the top end of the payment touch screen 14 are connected with each other; and the back surface of the operation touch screen 13 forms an angle with the back surface of the payment touch screen 14. As a result, when the holder holds the secure payment device of the present embodiment to request the consumer for a checkout, the password information entered by the consumer is prevented from being viewed by the holder due to that the payment touch screen 14 is bended and extended in a direction other than the line of sight of the holder.

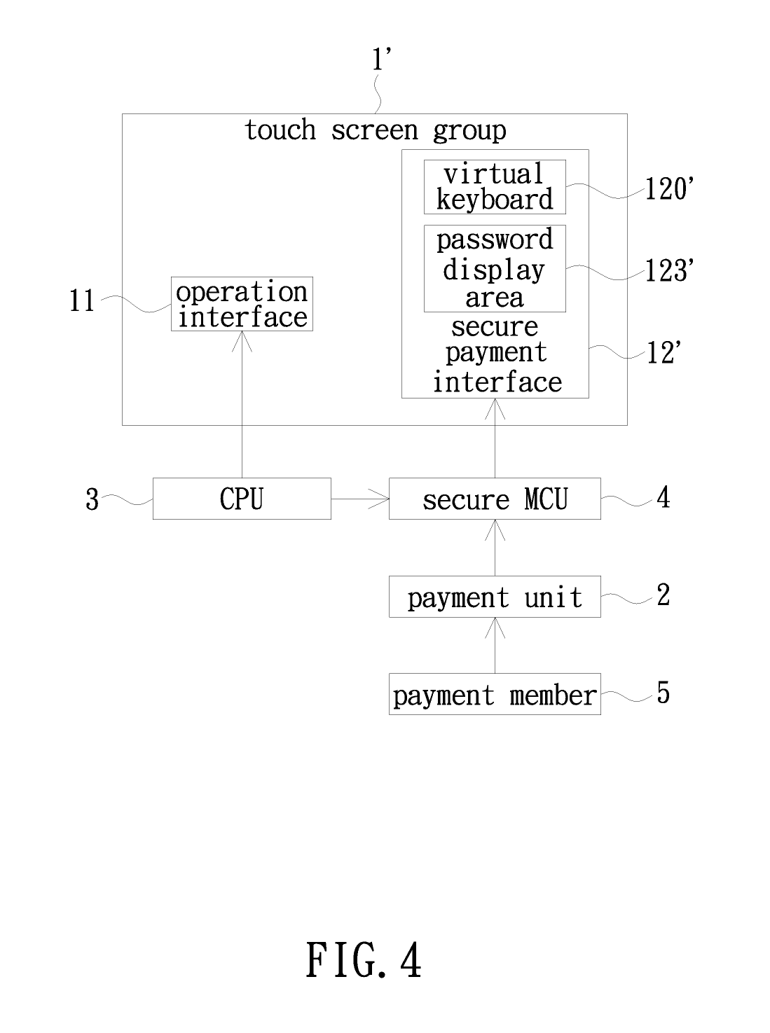

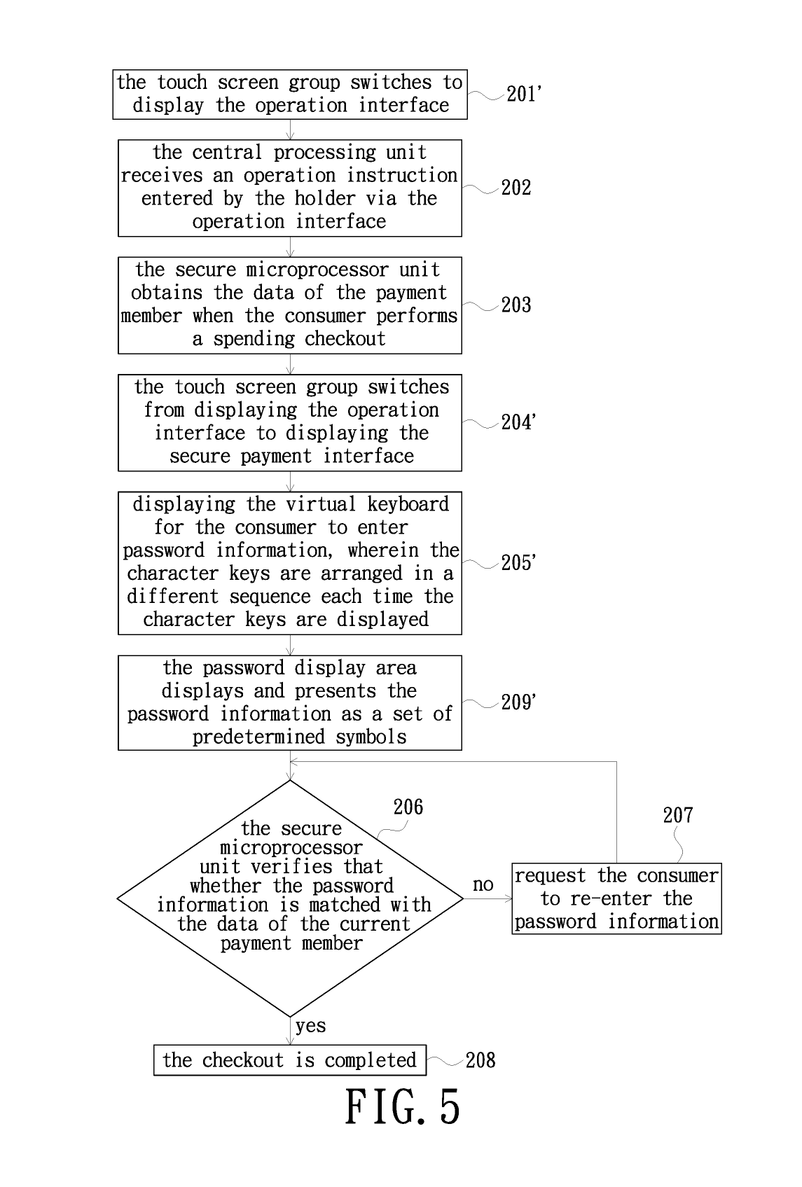

FIG. 4 is a block diagram of a secure payment device in accordance with another embodiment of the present invention. As shown in FIG. 4, in the present embodiment, the touch screen group 1′ is a single touch screen and configured to display the operation interface 11 or the secure payment interface 12′. FIG. 5 is a flow chart of a secure payment method for the secure payment device shown in FIG. 4 in accordance with an embodiment of the present invention. Please refer to FIGS. 4 and 5 together. First, when the holder wants to operates the secure payment device, the touch screen group 1′ is controlled by the central processing unit 3 to display the operation interface 11 (step 201′). When the consumer wants to perform a checkout, the touch screen group 1′ is controlled by the central processing unit 3 to switch to the secure payment interface 12′ from the display the operation interface 11 for the consumer to operate (step 204′).

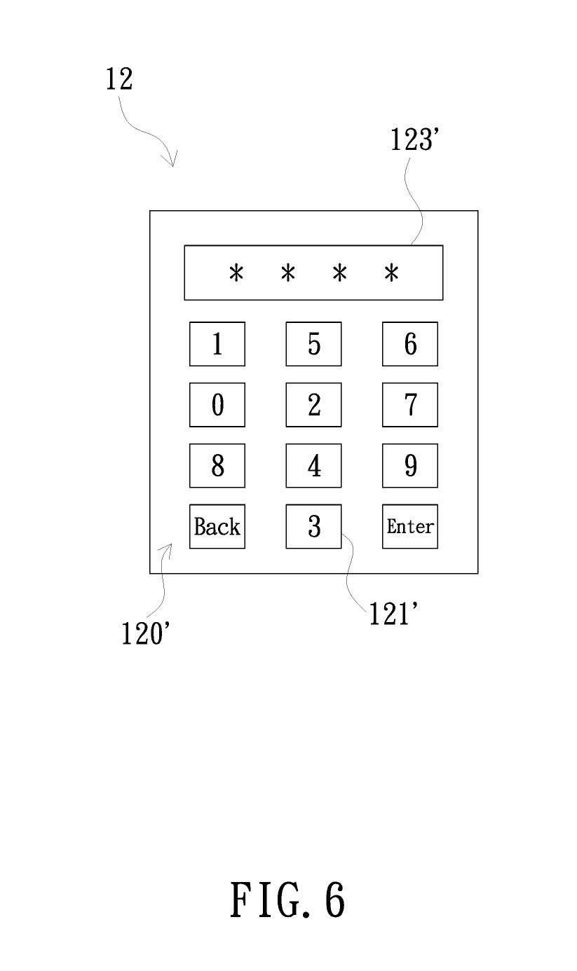

FIG. 6 is a schematic view of a virtual keyboard of a secure payment interface of the secure payment device shown in FIG. 4. As shown in FIG. 6, the secure payment interface 12′ of the present embodiment further includes a password display area 123′, and the virtual keyboard 120′ has a plurality of character keys 121′ (the character keys 121′ of the present embodiment are exemplified by numerical keys, but the present invention is not limited thereto). Please refer to FIGS. 5 and 6 together. First, the secure microprocessor unit 4 displays the virtual keyboard 120′ via the secure payment interface 12′, and the character keys 121 are arranged in a different sequence each time when the character keys 121 are displayed by the virtual keyboard 120′ (step 205′); and correspondingly, the secure microprocessor unit 4 is configured to analyze what the number entered by the consumer is based on the relationship between the key coordinate and the corresponding number. In the step 205′, it is understood that the virtual keyboard 120′ may be displayed by the central processing unit 3 via the secure payment interface 12′, and then the secure microprocessor unit 4 analyzes what the number entered by the consumer is.

Thereafter, when the consumer presses the virtual keyboard 120′, the password information entered by the consumer is displayed by the password display area 123′, and the password information displayed by the password display area 123′ is presented as a set of predetermined symbols (step 209′) (the predetermined symbol of the present embodiment is “*”, but the present invention is not limited thereto), so that the password information entered by the consumer is prevented from being exposed.

In summary, in the secure payment device and the secure payment method thereof of the present invention, the central processing unit is for controlling and driving the secure payment device only, and the secure microprocessor unit is for receiving the financial transaction data and verifying the connection to the consumer separately. Because the secure microprocessor unit operates independently, the financial transaction data cannot be eavesdropped directly from the central processing unit. Further, because the character keys of the virtual keyboard of the present invention are presented in different arrangement sequences each time when the character keys are displayed, the entered information would not be analyzed based on the positions of the character keys. Further, because the entered password is presented as predetermined symbols, the password information would not be exposed. Thus, the secure payment device and the secure payment method thereof of the present invention have enhanced security.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A secure payment device having a first mode and a second mode, wherein in the second mode, a payment procedure is activated to receive data of a payment member for a secure payment, and the secure payment device comprises:
a touch screen group, configured to display an operation interface and a secure payment interface, wherein in the first mode, the operation interface is configured to receive a first operation instruction, wherein in the second mode, the secure payment interface is configured to receive a second operation instruction, and the second operation instruction comprises authentication information for activating a payment function of the payment member;
a payment unit, configured to obtain the data of the payment member;
a central processing unit, signal connected to the touch screen group, wherein in the first mode, the central processing unit is configured to receive the first operation instruction via the operation interface; and
a secure microprocessor unit, signal connected to the central processing unit, the touch screen group and the payment unit, wherein in the second mode, the secure microprocessor unit is configured to obtain the data of the payment member by the payment unit, receive the second operation instruction via the secure payment interface, and activate the payment function based on a comparing result of the authentication information and the data of the payment member.

2. The secure payment device according to claim 1, wherein the touch screen group comprises:
an operation touch screen, signal connected to the central processing unit and configured to display the operation interface and receive the first operation instruction; and
a payment touch screen, signal connected to the secure microprocessor unit and configured to display the secure payment interface and receive the second operation instruction.

3. The secure payment device according to claim 2, wherein a top end of the operation touch screen and a top end of the payment touch screen are connected to each other, and a back surface of the operation touch screen forms an angle with a back surface of the payment touch screen.

4. The secure payment device according to claim 1, wherein the touch screen group is controlled by the central processing unit to switch to display the operation interface or the secure payment interface.

5. The secure payment device according to claim 1, wherein the authentication information is password information, fingerprint information, iris information or a combination thereof.

6. The secure payment device according to claim 5, wherein the secure payment interface comprises a virtual keyboard configured to input the password information.

7. The secure payment device according to claim 6, wherein the secure payment interface further comprises a password display area configured to display the password information, and the password information displayed in the password display area is presented as a predetermined symbol.

8. The secure payment device according to claim 6, wherein the virtual keyboard has a plurality of character keys, and the character keys are arranged in a different sequence each time when the character keys are displayed by the virtual keyboard.

9. The secure payment device according to claim 1, wherein the payment member is a chip credit card, and the payment unit is a chip card reader.

10. The secure payment device according to claim 1, wherein the payment member is a near field communication medium, and the payment unit is a near field communication reader.

11. A secure payment method for a secure payment device, wherein the secure payment device has a first mode and a second mode, wherein in the second mode, a payment procedure is activated to receive data of a payment member for a secure payment, the secure payment device comprises a touch screen group, a payment unit, a central processing unit and a secure microprocessor unit, the touch screen group is configured to display an operation interface and a secure payment interface, the central processing unit is signal connected to the touch screen group, the secure microprocessor unit is signal connected to the central processing unit, the touch screen group and the payment unit, and the secure payment method comprises steps of:
a) in the first mode, configuring central processing unit to receive a first operation instruction via the operation interface;
b) in the second mode, configuring the secure microprocessor unit to obtain the data of the payment member by the payment unit;
c) configuring the secure microprocessor unit to receive a second operation instruction via the secure payment interface, wherein the second operation instruction comprises authentication information for activating a payment function of the payment member; and
d) configuring the secure microprocessor unit to activate the payment function based on a comparing result of the authentication information and the data of the payment member.

12. The secure payment method according to claim 11, wherein the touch screen group comprises an operation touch screen and a payment touch screen, the operation touch screen is signal connected to the central processing unit, the payment touch screen is signal connected to the secure microprocessor unit, wherein prior to the step a), the secure payment method further comprises a step e) configuring the operation touch screen to display the operation interface and receive the first operation instruction, wherein between the step b) and the step c), the secure payment method further comprises a step f) configuring the payment touch screen to display the secure payment interface and receive the second operation instruction.

13. The secure payment method according to claim 12, wherein a top end of the operation touch screen and a top end of the payment touch screen are connected to each other, and a back surface of the operation touch screen forms an angle with a back surface of the payment touch screen.

14. The secure payment method according to claim 11, wherein prior to the step a), the secure payment method further comprises a step g) configuring the central processing unit to control the touch screen group to display the operation interface, wherein between the step b) and the step c), the secure payment method further comprises a step h) configuring the central processing unit to control the touch screen group to switch from displaying the operation interface to displaying the secure payment interface.

15. The secure payment method according to claim 11, wherein the authentication information is password information, fingerprint information, iris information or a combination thereof.

16. The secure payment method according to claim 15, wherein the secure payment interface comprises a virtual keyboard, and the step c) further comprises a step c1) displaying the virtual keyboard for inputting the password Information.

17. The secure payment method according to claim 16, wherein the secure payment interface further comprises a password display area, wherein after the step c1), the secure payment method further comprises a step c2) configuring the password display area to display the password information, wherein the password information displayed in the password display area is presented as a predetermined symbol.

18. The secure payment method according to claim 16, wherein the virtual keyboard has a plurality of character keys, and the step c1) further comprises a step c11) arranging the character keys in a different sequence each time when the character keys are displayed by the virtual keyboard.

19. The secure payment method according to claim 11, wherein the payment member is a chip credit card, and the payment unit is a chip card reader.

20. The secure payment method according to claim 11, wherein the payment member is a near field communication medium, and the payment unit is a near field communication reader.
